(19) United States
(12) Patent Application Publication
(10) Pub. No.: US 2006/0204296 A1
(43) Pub. Date: Sep. 14, 2006

(54) Image forming apparatus

(75) Inventors: Akihisa Maruyama, Kanagawa (JP); Yasuhiro Oda, Kanagawa (JP); Miho Ikeda, Kanagawa (JP); Koichiro Yuasa, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/225,216

(22) Filed: Sep. 14, 2005

(30) Foreign Application Priority Data
Mar. 9, 2005 (JP) P2005-065234

(51) Int. Cl. G03G 21/00

(52) U.S. Cl. 399/349; 399/359

(57) ABSTRACT

An image forming apparatus includes an image carrier, a cleaning device and a developing device. The cleaning device recovers a toner remaining on the image carrier. The toner recovered by the cleaning device is supplied to the developing device. The cleaning device includes a conductive brush member and an elastic blade. The conductive brush member is disposed on upstream of the image carrier in a rotation direction of the image carrier so as to be in contact with the image carrier. The conductive brush member recovers the toner remaining on the image carrier electrostatically. The elastic blade is disposed on downstream of the image carrier so as to be in contact with the image carrier. A toner recovered by the conductive brush member is supplied to the developing device and used in image formation again. A toner recovered by the elastic blade is discarded.

### BACKGROUND OF THE INVENTION

1. Field of the Invention

The present invention relates to an image forming apparatus using an electrophotographic method, such as a copier, printer, or facsimile, and more particularly, to an image forming apparatus that reuses (reclaim) a toner recovered by a cleaning device in image formation.

2. Description of the Related Art

There is an related art that discloses an image forming apparatus using an electrophotographic method, (such as a copier, printer, or facsimile), in which a toner recovered by a cleaning device is reused (reclaimed) to form an image.

A cleaning device disclosed above is disposed adjacent to a rotatable image carrier to remove a toner remaining on the image carrier after transferring. The cleaning device includes an elastic blade abutting against the image carrier, a rotatable mixing transfer member, a first toner recovering member and a second toner recovering member. The rotatable mixing conveyance member is disposed on upstream of the elastic blade in the rotation direction of the image carrier so as to face the image carrier in a non-contact manner. The mixing conveyance member mixes and conveys the toner. The first toner recovering member is disposed above the mixing conveyance member to recover the toner. The second toner recovering member is disposed below the mixing conveyance member to recover the toner.

In the cleaning device disclosed above, the elastic blade abutting against the image carrier recovers the toner. However, in a cleaning method using the elastic blade, toner stays at a tip of the blade and thus, an aggregate is formed easily there. Also, it is difficult to separate the aggregate by an electric field. Therefore, when the aggregate is fed to a developing device, it is mixed with a toner image formed on the image carrier. In this case, if the toner image exists in the vicinity of the mixed aggregate, a white point due to a transfer failure appears. On the other hand, when the toner image does not exist in the vicinity of the mixed aggregate, a printed point appears, which causes image defects.

In the cleaning device, a cleaning method using a brush cleaner can prevent the aggregate of the toner from being formed. However, in this case, the cleaning performance of the brush cleaner is lower than that of the elastic blade.

Recently, high definition and a long life span have been required for the image forming apparatus, such as a copier, printer, or facsimile. Also, various additives, such as a transfer additive and a cleaning additive, have been added to a developer in large quantities.

Accordingly, in the image forming apparatus, which employs a reclaim system of reusing the toner recovered by the cleaning device, various additives remain on the image carrier in great quantities without being transferred onto a sheet due to a charged polarity or an adhesive property. In this case, if the additives are recovered by the cleaning device and are then supplied to the developing device again, the density of the additives in the developer rises. Thus, a charging failure occurs, which causes defects in image quality, such as the lowering of density and fogging.

Another technique has already proposed for solving this problem.

A developing device according to JP 2001-312132 A guides a developer, which is housed in a main body and includes at least a toner and mobile minute particles, to a developing region facing an image carrier by a developer transfer member, and supplies the toner of the developer to the surface of the image carrier to form a toner image on the image carrier. Then, after transferring the toner image onto a transfer media, the developing device recovers a residue, such as the toner remaining on the surface of the image carrier, and then returns the recovered toner to the main body by a returning unit. The developing device supplies a new toner from a toner-supplying device to the main body. In this case, an amount of metal stearate to be supplied to the main body is set to be less than that of the metal stearate added to the toner in an initial state before supply, by using a negative-polarity toner to which the metal stearate is added.

### SUMMARY OF THE INVENTION

However, the above-described techniques have the following problems. That is, in the developing device described above, the amount of metal stearate, which serves as a cleaning additive and is added to new toner, is set to be less than that of the metal stearate added to the toner in the initial state before supply. However, as described above, it is difficult to prevent the cleaning additive from being accumulated in the developer of the developing device during reclaim. Also, the optimum amount of the cleaning additive varies depending on the kind or amount of the toner. Therefore, if the amount of the metal stearate, which serves as a cleaning additive and is added to a new toner, is set to be less than that of the metal stearate added to the initial toner before supply, a life span can be lengthened to some extents, but the density of the additives of the developer rises, and thus a charging failure occurs, which causes defects in image quality, such as the lowering of density and fogging.

the present invention has been made in view of the above circumstances and provides an image forming apparatus, which may prevent defects in image quality, such as low density and fogging, due to a charging failure caused by an increase in the density of the additives of the recovered developer, even if various additives are added to the developer.

According to one embodiment of the invention, an image forming apparatus includes an image carrier, a cleaning device and a developing device. The cleaning device recovers a toner remaining on the image carrier. The toner recovered by the cleaning device is supplied to the developing device. The cleaning device includes a conductive brush member and an elastic blade. The conductive brush member is disposed on upstream of the image carrier in a rotation direction of the image carrier so as to be in contact with the image carrier. The conductive brush member recovers the toner remaining on the image carrier electrostatically. The elastic blade is disposed on downstream of the image carrier so as to be in contact with the image carrier. A toner recovered by the conductive brush member is supplied to the developing device and used in image formation again. A toner recovered by the elastic blade is discarded.

### BRIEF DESCRIPTION OF THE DRAWINGS

Embodiments of the invention will be described in detail based on the following figures, wherein:

FIG. 1 is a diagram showing main parts of a color multifunction machine serving as an image forming apparatus according to a first embodiment of the invention;

FIG. 2 is a diagram showing the overall structure of the color multifunction machine serving as the image forming apparatus according to the first embodiment of the invention;

FIG. 3 is a diagram showing an image forming section of the color multifunction machine serving as the image forming apparatus according to the first embodiment of the invention; and

FIG. 4 is a diagram showing main parts of an image forming apparatus according to a second embodiment of the invention.

### DETAILED DESCRIPTION OF THE EMBODIMENTS OF THE INVENTION

Hereinafter, embodiments of the invention will be described with reference to the accompanying drawings.

### First Embodiment

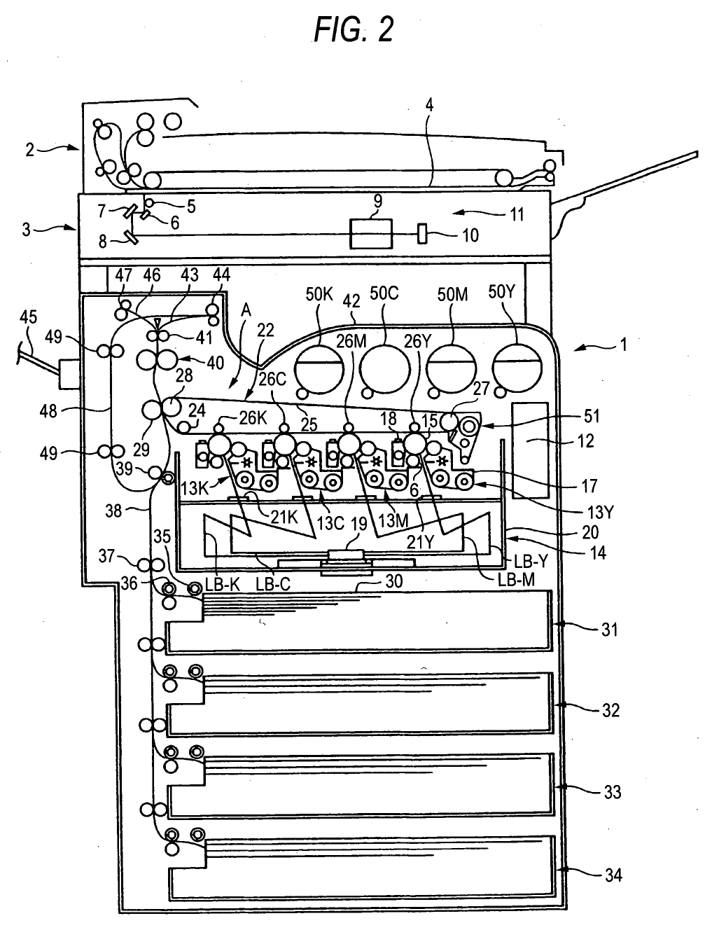

FIG. 2 is a diagram showing a structure of a color multifunction machine serving as an image forming apparatus according to a first embodiment of the invention. The color multifunction machine has all functions of a copier, a printer, and a facsimile.

As shown in FIG. 2, the color multifunction machine has a scanner 2 on an upper portion thereof as an image-scanning device, and is connected to a personal computer (not shown) through a network (not shown).

The color multifunction machine functions as a copier for copying an image of a document scanned by the scanner, a printer for printing an image on the basis of image data transmitted from the personal computer, and a fax for transmitting or receiving image data over telephone lines.

In FIG. 2, reference numeral 1 denotes a main body of the color multifunction machine. An automatic document feeder (ADF) 2 for automatically feeding documents (not shown) one by one and an image input terminal (IIT) 3 for scanning the image of the document fed by the automatic document feeder 2 are arranged on the upper portion of the main body 1 of the color multifunction machine. The image input terminal (IIT) 3 illuminates the document placed on a platen glass 4 by a light source 5, and scans and exposes an optical image reflected from the document to an image scanning element 10 composed of, for example, a CCD, using a reduction optical system 11 including a full-rate mirror 6, half-rate mirrors 7 and 8, and an imaging lens 9 so as to scan a color reflected optical image at a predetermined dot density (for example, 16 dots/mm) by using the image scanning element 10.

The reflected optical image of the document scanned by the image input terminal 3 is transmitted to an image processing system (IPS) 12 as reflectivity data (eight bits) of red (R), green (G), and blue (B). The image processing system 12 performs a predetermined image process that includes shading correction, misalignment correction, brightness/color space conversion, gamma correction, frame erase, color/movement editing, etc., on the image data of the document, if necessary, as described below. In addition, the image processing system 12 also performs the predetermined image process on the image data transmitted from a personal computer (not shown), etc.

Furthermore, the image data on which predetermined image process is performed by the image processing system 12 is converted into yellow (Y), magenta (M), cyan (C), and black (K) gray-scale data (eight bits), and is then transmitted to a raster output scanner (ROS) shared by image forming units 13Y, 13M, 13C, and 13K for yellow (Y), magenta (M), cyan (C), and black (K). In this case, in the ROS 14 serving as an image exposure device, a laser beam LB performs image exposure according to the gray-scale data of a predetermined color. The above-mentioned image is not limited to the color image, of course, but may be a monochrome image.

As shown in FIG. 2, an image forming unit A is arranged in the main body 1 of the color multifunction machine. The four image forming units 13Y, 13M, 13C, and 13K for yellow (Y), magenta (M), cyan (C), and black (K) are arranged parallel to each other at predetermined intervals in the horizontal direction in the image forming unit A.

The four image forming units 13Y, 13M, 13C, and 13K have same structure. Each image forming unit mainly includes a photoconductor drum 15 serving as an image carrier, a charging roller 16 for primary charging, the ROS 14 serving as the image exposing device, a developing device 17 and a cleaning device 18. The photoconductor drum 15 is rotated at a predetermined speed. The charging roller 16 uniformly charges the surface of the photoconductor drum 15. The ROS 14 forms an electrostatic latent image on the surface of the photoconductor drum 15 by exposing an image corresponding to a predetermined color. The developing device 17 develops the electrostatic latent image formed on the surface of the photoconductor drum 15 with a toner having a predetermined color. The cleaning device 18 cleans the surface of the photoconductor drum 15. The photoconductor drum 15 and an image-forming member arranged in the vicinity thereof are integrated into a single unit so as to be separately replaced from the main body 1 of the color multifunction machine.

As shown in FIG. 2, the ROS 14 is constructed so as to be shared by the four image forming units 13Y, 13M, 13C, and 13K, and modulates four semiconductor lasers (not shown) according to gray-scale data of each color to emit laser beams LB-Y, LB-M, LB-C, and LB-K from the semiconductor lasers according to the gray-scale data. Furthermore, the ROS 14 may be separately provided to each of the plurality of image forming units. The laser beams LB-Y, LB-M, LB-C, and LB-K emitted from the semiconductor lasers are radiated to a polygon mirror 19 through a f-θ lens (not shown), and are deflectively scanned by the polygon mirror 19. The laser beams LB-Y, LB-M, LB-C, and LB-K deflectively scanned by the polygon mirror 19 are obliquely scanned to exposure points on the photoconductor drum 15 through an imaging lens and a plurality of mirrors (not shown).

As shown in FIG. 2, since the ROS 14 scans and exposes the image on the photoconductor drum 15 from the below, there is a fear that the toner is fallen on the ROS 14 from the developing device 17 of each of the image forming units 13Y, 13M, 13C, and 13K arranged above the ROS 14, so that the ROS 14 is contaminated. For this reason, a rectangular parallelepiped frame 20 seals the circumference of the ROS 14. In addition, windows 21Y, 21M, 21C, and 21K made of a transparent material, such as glass, are provided on the upper portion of the frame 20 serving as shielding members in order to radiate the four laser beams LB-Y, LB-M, LB-C, and LB-K onto the photoconductor drums 15 of the image forming units 13Y, 13M, 13C, and 13K, respectively.

The image data of each color is sequentially output from the image processing system 12 to the ROS 14 shared by the image forming units 13Y, 13M, 13C, and 13K for (Y), magenta (M), cyan (C), and black (K), and the laser beams LB-Y, LB-M, LB-C, and LB-K radiated from the ROS 14 according to the image data are scanned to the surfaces of the corresponding photoconductor drums 15 to form electrostatic latent images. The electrostatic latent images formed on the photoconductor drums 15 are developed by developing devices 17Y, 17M, 17C, and 17K as yellow (Y), magenta (M), cyan (C), and black (K) toner images.

The yellow (Y), magenta (M), cyan (C), and black (K) toner images sequentially formed on the photoconductor drums 15 of the image forming units 13Y, 13M, 13C, and 13K are transferred in a superposed manner, by four primary transfer rollers 26Y, 26M, 26C, and 26K, on an intermediate transfer belt 25 of a transfer unit 22, which is arranged on the upper portion of the image forming units 13Y, 13M, 13C, and 13K. Each of the primary transfer rollers 26Y, 26M, 26C, and 26K is arranged on the back side of the intermediate transfer belt 25 so as to correspond to the photoconductor drum 15 of each of the image forming units 13Y, 13M, 13C, and 13K. A volume resistance value of each of the primary transfer rollers 26Y, 26M, 26C, and 26K according to the present embodiment is adjusted in a range of 10⁵ Ω·cm to 10⁸ Ω·cm. Furthermore, a transfer bias power source (not shown) is connected to the primary transfer rollers 26Y, 26M, 26C, and 26K. A transfer bias having a polarity (a positive polarity in the present embodiment) opposite to a predetermined toner polarity is applied to the primary transfer rollers 26Y, 26M, 26C, and 26K at a predetermined timing.

As shown in FIG. 2, the intermediate transfer belt 25 is wound on a drive roller 27, a tension roller 24, and a backup roller 28 with a predetermined tension. In this case, the intermediate transfer belt 25 is driven by the drive roller 27, which is circularly rotated at a predetermined speed in the direction of arrow by a dedicated motor (not shown) having an excellent constant-speed property. The intermediate transfer belt 25 is made of a material (rubber or resin) not causing charge-up.

As shown in FIG. 2, the yellow (Y), magenta (M), cyan (C), and black (K) toner images transferred on the intermediate transfer belt 25 in a superposed manner are secondarily transferred on a sheet 30, serving as a sheet material, by a secondary transfer roller 29 that comes into pressure contact with the backup roller 28. The sheet 30 on which the toner images having the respective colors have been transferred is fed to a fixing device 40 provided above the backup roller 28. The secondary transfer roller 29 laterally presses the backup roller 28 so that the toner images having each color are secondarily transferred on the sheet 30 fed from the lower side to the upper side.

The sheet 30 having a predetermined size is fed one by one by a feed roller 35 and a retard roller 36 via a sheet feeding path 38 including a feed roller 37 from any one of a plurality of sheet feeding trays 31, 32, 33 and 34, which are arranged in multiple stages on the lower portion of the main body 1 of the color multifunction machine. The feeding of the sheet 30 fed from any one of the sheet feeding trays 31, 32, 33 and 34 is temporarily stopped by a resist roller 39, and is then fed to a secondary transfer position of the intermediate transfer belt 25 by the resist roller 39 in synchronization with the image transferred on the intermediate transfer belt 25.

As shown in FIG. 2, the sheet 30 on which the toner images having each color have been transferred is fixed by heat and pressure by the fixing device 40. Then, the sheet 30 is discharged to a face-down tray 42, serving as a first discharge tray, provided on the upper portion of the main body 1 by a discharge roller 44, which is arranged at an outlet of a first sheet feeding path 43, with an image-formed surface of the sheet facing downward, through the first sheet feeding path 43.

In addition, in a case where the sheet 30 having the image thereon is discharged with the image-formed surface facing upward, as shown in FIG. 2, a discharge roller 47 discharges the sheet 30 through a second sheet feeding path 46 to a face-up tray 45, which serves as a second tray and is provided in the side portion (left side in FIG. 2) of the main body 1, with an image-formed surface of the sheet 30 facing upward. The discharge roller 47 is arranged at an outlet of the second sheet feeding path 46.

When the full color double-sided copying is performed in the above-mentioned color multifunction machine, as shown in FIG. 2, the sheet 30 having a fixed image on one surface thereof is not immediately discharged to the face-down tray 42 by the discharge roller 44. That is, the feed direction of the sheet 30 is changed by a switching gate (not shown), and the feeding of the sheet 30 is temporarily stopped to reverse the feed direction. After that, the sheet 30 is fed to a sheet feeding path 48 for double-sided copying by the discharge roller 44. Via the sheet feeding path 48 for double-sided copying, the sheet 30 is again fed to the resist roller 39 by a feed roller 49 arranged along the sheet feeding path 48 in the state in which the surface of the sheet 30 is inverted. Subsequently, an image is transferred and fixed onto the rear surface of the sheet 30, and then the sheet 30 is discharged to the face-down tray 42 or the face-up tray 45 through the first sheet feeding path 43 or the second sheet feeding path 46.

In FIG. 2, reference numerals SOY, 50M, 50C, and 50K denote toner cartridges, which supply toners having predetermined colors to the developing devices 17Y, 17M, 17C, and 17K for yellow (Y), magenta (M), cyan (C), and black (K). Reference numeral 51 denotes a cleaning device for cleaning the surface of the intermediate transfer belt 25.

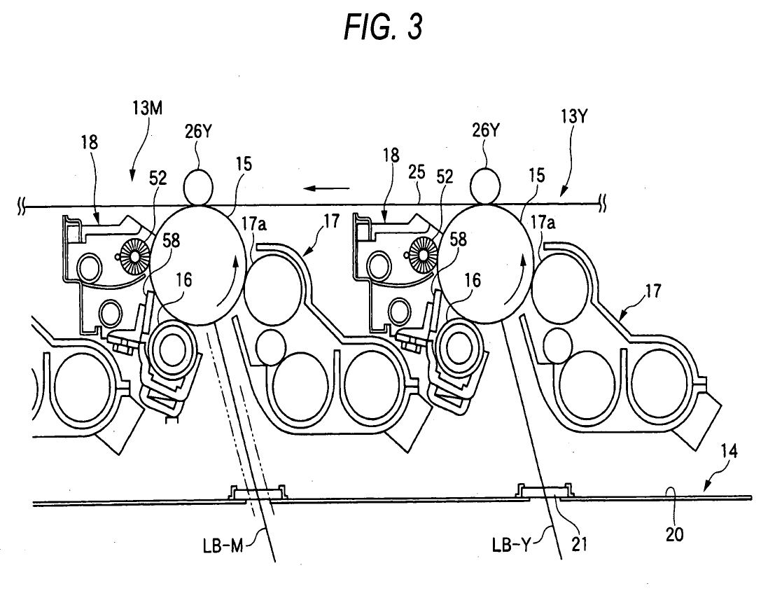

FIG. 3 is a diagram showing each image forming unit of the color multifunction machine.

As shown in FIG. 3, the four image forming units 13Y, 13M, 13C, and 13K for yellow, magenta, cyan, and black have same structure. As described above, yellow, magenta, cyan, and black toner images are sequentially formed at a predetermined timing in the four image forming units 13Y, 13M, 13C, and 13K. As mentioned above, the image forming units 13Y, 13M, 13C, and 13K for the respective colors include photoconductor drums 15, respectively. The charging roller 16 for primary charging uniformly charges the surface of each photoconductor drum 15. Then, the image forming laser beam LB radiated from the ROS 14 according to the image data is scanned to the surface of each photoconductor drum 15 in order to form an electrostatic latent image for each color. The laser beam LB is radiated onto the surface of the photoconductor drum 15 in the upper left direction, which is slightly inclined from the vertical direction. The developing rollers 17a of the developing devices 17 of the image forming units 13Y, 13M, 13C, and 13K develops the electrostatic latent images formed on the photoconductor drums 15 are developed into visual toner images with yellow, magenta, cyan, and black toners. The visual toner images are transferred in a superposed manner onto the intermediate transfer belt 25 in sequence due to the charging of the primary transfer rollers 26. The developing device 17 of each of the image forming units 13Y, 13M, 13C, and 13K may use a two-component developer composed of toners and carriers, or may use a one-component developer composed of only toner. Furthermore, a cleaning additive, such as Znst or CeO₂, is added to the toner to improve a cleaning property. The cleaning additive is charged so as to have a polarity opposite to the polarity of the toner, that is, a positive polarity.

After a process of transferring a toner image is completed, a cleaning device 18 serving as a cleaning device removes the residual toner from the surfaces of the photoconductor drums 15. Then, an image forming process is prepared. The residual toner after transfer recovered by the cleaning device 18 is fed to the corresponding developing devices 17 in order to be reused in a developing process.

According to the first embodiment, an image forming apparatus includes an image carrier, a cleaning device and a developing device. The cleaning device recovers a toner remaining on the image carrier. The toner recovered by the cleaning device is supplied to the developing device. The cleaning device includes a conductive brush member and an elastic blade. The conductive brush member is disposed on upstream of the image carrier in a rotation direction of the image carrier so as to be in contact with the image carrier. The conductive brush member recovers the toner remaining on the image carrier electrostatically. The elastic blade is disposed on downstream of the image carrier so as to be in contact with the image carrier. A toner recovered by the conductive brush member is supplied to the developing device and used in image formation again. A toner recovered by the elastic blade is discarded.

Furthermore, in the image forming apparatus according to the first embodiment, a cleaning additive is added to the toner, and the cleaning additive is charged with a polarity opposite to that of the toner.

In addition, in the image forming apparatus according to the first embodiment, the conductive brush member is disposed above the elastic blade in a gravitational direction.

Further, the image forming apparatus according to the first embodiment further includes a conveyance passage for reuse, through which the toner recovered by the cleaning device is supplied to the developing device. The cleaning device further comprises a scraping member that abuts against a surface of the conductive brush member to scrape the toner recovered by the conductive brush member so as to guide a scraped toner to the conveyance passage.

Furthermore, in the image forming apparatus according to the first embodiment, a voltage applied to the conductive brush member is set so that the conductive brush member does not recover the toner remaining on the image carrier under a condition that a large amount of toner remains on the image carrier.

That is, as shown in FIGS. 2 and 3, the image forming apparatus includes the cleaning devices 18. After the image forming units 13Y, 13M, 13C, and 13K for yellow (Y), magenta (M), cyan (C), and black (K), form toner images having the respective colors on the surfaces of the photoconductor drums 15Y, 15M, 15C, and 15K, the primary transfer rollers 26Y, 26M, 26C, and 26K transfer the toner images onto the intermediate transfer belt 25 in a superposed manner. Then, the cleaning devices 18 recover the residual toner remaining on the photoconductor drums 15Y, 15M, 15C, and 15K after the transfer.

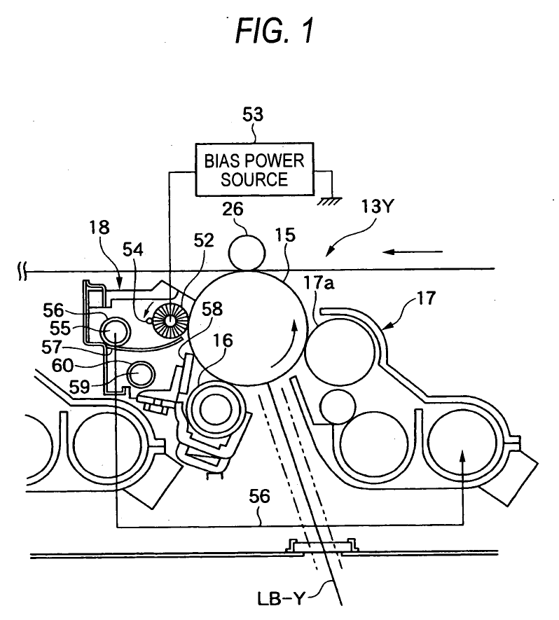

As shown in FIGS. 1 to 3, each of the cleaning devices 18 includes a conductive brush 52 serving as a conductive brush member. The conductive brush 52 is disposed to be in contact with the photoconductor drum 15 on the upstream of the photoconductor drum 15 in the rotation direction thereof in order to electrostatically recover the residual toner remaining on the photoconductor drum 15 after the transfer. The conductive brush 52 has a diameter φ of about 12 mm to 14 mm, and is rotated at a predetermined speed in a direction opposite to the rotation direction of the photoconductor drum 15 by a driving source (not shown). The conductive brush 52 includes a cylindrical conductive base and conductive fibers. The conductive fibers having a size of two deniers are implanted on the surface of the conductive base at a density of about 200,000 pieces/inch². The conductive brush 52 abuts against the photoconductor drum 15 so as to bite into the surface thereof by about 0.1 mm. Moreover, a circumferential velocity of the conductive brush 52 is set, for example, 1.5 to 2.0 times as large as that of the surface of the photoconductor drum 15.

Furthermore, a bias power source 53 applies a voltage of a predetermined polarity to the conductive brush 52. The voltage applied to the conductive brush 52 has, for example, a polarity opposite to a charge polarity of the toner. That is, a voltage having a positive polarity, which is the same as that of the cleaning additive added to the toner such as Znst or CeO₂, is applied to the conductive brush 52. In this case, the voltage is set to about +400 V. However, the voltage may be in a range of about +100 V to 300 V, or may be set to a ground voltage (0 V). Moreover, the bias power source 53 may be constructed so that a voltage of a negative polarity, which is the same as that of the charge polarity of the toner, is applied to the conductive brush 52 at a predetermined timing, as described later.

A flicker bar 54 serving as a scraping member abuts against the surface of the conductive brush 52. The flicker bar 54 mechanically scrapes the residual toner recovered by the conductive brush 52. A conveyance device 55 for reuse (reclaim) conveys the residual toner scrapped by the flicker bar 54 from the surface of the conductive brush 52, to the developing device 17 via a conveyance path 56 for reclaim. The conveyance device 55 is formed of an auger or the like. The conveyance path 56 is formed of a cylindrical conveyance member. member. The conveyed toner is supplied together with or without a new toner, to the developing device 17 and is reused in the developing process.

The inside of the cleaning device 18 is partitioned into upper and lower portions by a partitioning wall 57. A cleaning blade 58 serving as an elastic blade is disposed below the conductive brush 52 in the gravitational direction. The cleaning blade 58 is made of an elastic material such as urethane. Since the cleaning blade 58 is in contact with the surface of the photoconductor drum 15 from a direction opposite to the rotation direction of the photoconductor drum 15, the cleaning blade 58 can efficiently remove and recover attachment such as the residual toner after transfer or the cleaning additive remaining on the surface of the photoconductor drum 15. A discard toner conveyance device 59 conveys the attachment such as the residual toner after transfer or the cleaning additive recovered by the cleaning blade 58 to a discarding box (not shown) through a conveyance passage 60 for discard. Then, the conveyed toner is discarded. The conveyance device 59 is formed of an auger or the like.

The conductive brush 52 is disposed on the upstream of the cleaning blade 58 in the rotation direction of the photoconductor drum 15, and above the cleaning blade 58 in the gravitational direction. Therefore, it is possible to allow the conductive brush 52 to recover the residual toner after transfer, in preference to the cleaning blade 58. Also, it is possible to prevent the toner recovered by the cleaning blade 58 from being mixed with that recovered by the conductive brush 52.

In the first embodiment, under a condition that a larger amount of the toner after transfer remains on the surface of the photoconductor drum 15, such as a case where a sheet 30 is jammed or a case where sheets 30 are successively printed, a voltage applied to the conductive brush 52 is set to have a negative polarity, which is the same as that of the transfer toner, so that the toner remaining on the surface of the photoconductor drum 15 is not recovered.

In this way, a large amount of toner attached to the conductive brush 52 is discharged so as to prevent a larger amount of toner from being attached on the conductive brush 52. Also, it is possible to prevent the recovery efficiency of the toner from being lowered due to a larger amount of toner stacking on the conductive brush 52.

As mentioned above, in the image forming apparatus according to the first embodiment, even when various additives are added to the developer, it is possible to prevent defects in image quality, such as low density or fog, from being caused due to the charging failure caused by an increase in the density of the additive in the recovered developer.

That is, in the image forming apparatus according to the first embodiment, as shown in FIGS. 2 and 3, the image forming units 13Y, 13M, 13C, and 13K for yellow (Y), magenta (M), cyan (C), and black (K) form the toner images having the respective color on the photoconductor drums 15Y, 15M, 15C, and 15K. Then, after the primary transfer rollers 26Y, 26M, 26C, and 26K transfer the toner images have the respective colors formed on the photoconductor drums 15Y, 15M, 15C, and 15K onto the intermediate transfer belt 25 in a superposed manner, a full color or monochrome image is formed by collectively transferring and fixing the yellow (Y), magenta (M), cyan (C), and black (K) toner images onto the sheet 30.

The image forming units 13Y, 13M, 13C, and 13K for yellow (Y), magenta (M), cyan (C), and black (K) are constructed so as to respectively recover the residual toner remaining on the surfaces of the photoconductor drums 15Y, 15M, 15C, and 15K by the cleaning devices 18 in order to reuse a part of the recovered residual toner.

As shown in FIG. 1, each of the cleaning devices 18 includes the conductive brush 52, which is disposed on the upstream of the cleaning blade 58 in the rotation direction of each of the photoconductor drums 15Y, 15M, 15C, and 15K. Also, the conductive brush 52 is disposed above the cleaning blade 58 in the gravitational direction. A voltage of a positive polarity opposite to the polarity of the toner is applied to the conductive brush 52. For this reason, the residual toner remaining on the surfaces of the photoconductor drums 15 is mostly removed and recovered from the surfaces of the photoconductor drums 15 by electrostatic attracting force and mechanical scraping force of the conductive brush 52. At this time, since the mechanical scraping force of the conductive brush 52 is weaker than that of the cleaning blade 58, the cleaning additive, such as Znst or CeO₂, charged with a positive polarity, which is opposite to the polarity of the toner, is hardly recovered. Thus, the most of cleaning additive passes through the conductive brush 52.

The conveyance unit 55 for reclaim conveys the residual toner recovered by the conductive brush 52 to the developing device 17 via the conveyance path 56 for reclaim. The conveyance unit 55 is formed of, for example, an auger. Then, the conveyed toner is supplied to the developing device 17 together with a new toner to be reused in the developing process. Alternatively, the conveyed toner may be supplied separately from the new toner.

Each cleaning device 18 includes the cleaning blade 58 on the downstream of the conductive brush 52. The cleaning blade 58 removes and recovers the attachment, such the toner, which remains on the surface of the photoconductor drum 15 and is charged with an opposite polarity, and/or the cleaning additive composed of, for example, Znst or CeO₂. The conveyance unit 59 for discard toner conveys the recovered attachment to the discard box (not-shown) through the conveyance passage 60 for discard. Then, the conveyed attachment is discarded. The conveyance unit is formed of an auger.

In the image forming apparatus according to the first embodiment, even when various additives including the cleaning additives, such as Znst and CeO₂, are added to the toner, only the transfer residual toner is selectively recovered by the conductive brush 52 arranged on the upstream and is reused, and the cleaning additive, such as Znst or CeO₂, is recovered by the cleaning blade 58 arranged on the downstream. Therefore, even when various additives are added to the toner, it is possible to prevent defects in image quality, such as low density or fog, from being caused due to the charging failure caused by an increase in the density of the additive in the recovered developer.

Furthermore, under a condition that a larger amount of the toner after transfer remains on the surface of the photoconductor drum 15, such as a case where a sheet 30 is jammed or a case where sheets 30 are successively printed, a voltage applied to the conductive brush 52 is set to have a negative polarity, which is the same as that of the transfer toner, so that the toner remaining on the surface of the photoconductor drum 15 is not recovered.

In this case, the voltage applied to the conductive brush 52 may be set to have a negative polarity, which is the same as the polarity of the transfer toner. However, the voltage applied to the conductive brush 52 may be set to a ground voltage (0 V) so that the toner remaining on the photoconductor drum 15 is not recovered.

In addition, the voltage applied to the conductive brush 52 may be changed alternately and cyclically, that is, the negative polarity->the positive polarity->the negative polarity->the positive polarity, whenever the conductive brush 52 rotates one time or plural times. Thereby, it is possible to efficiently remove the toner adhered to the photoconductor drum 15, which is charged with a positive polarity or charged with an opposite polarity. Therefore, it becomes possible to keep the toner recovery efficiency good for a long time. As a result, it is possible to prevent filming caused by the toner remaining on the conductive brush 52.

### Second Embodiment

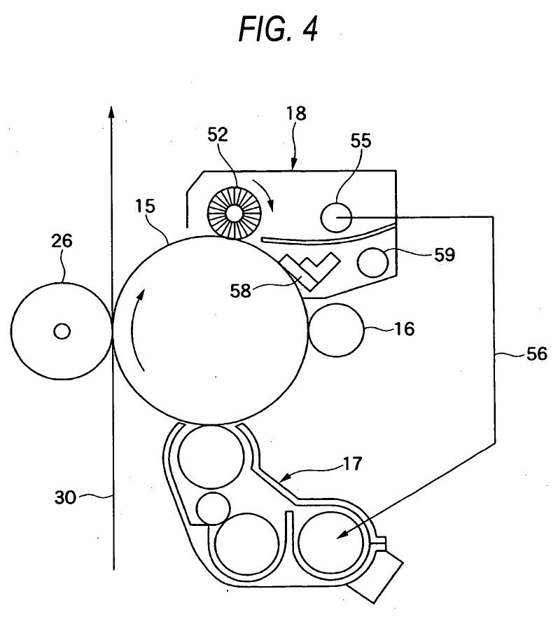

FIG. 4 is a diagram showing a second embodiment of the invention. In FIG. 4, the same parts as those in the first embodiment are indicated by the same reference numerals. In the second embodiment, the invention is applied to not a full color image forming apparatus, but a monochrome image forming apparatus.

That is, as shown in FIG. 4, the image forming apparatus according to the second embodiment includes a single photoconductor drum 15. A primary charging device 16, an exposure device 14, a developing device 17, a transfer roller 26, and a cleaning device 18 are arranged around the photoconductor drum 15 along the rotation direction of the photoconductor drum 15. In addition, a sheet 30 is fed from a lower side to an upper side along the side surface of the photoconductor drum 15.

Furthermore, as shown in FIG. 4, the cleaning device 18 is disposed above the photoconductor drum 15 in the image forming apparatus. The cleaning device 18 includes a conductive brush 52, which is disposed on the upstream of a cleaning blade 58 in the rotation direction of the photoconductor drum 15. In other words, the cleaning blade 58 is disposed on downstream of the conductive brush 52. Also, the conductive brush is disposed above the photoconductor drum 15.

According to this structure, the conductive brush 52 can recover the residual toner after transfer in preference to the cleaning blade 58. Also, it is possible to prevent the toner recovered by the cleaning blade 58 from being mixed with that recovered by the conductive brush 52.

Since the second embodiment has the same structure and function as those of the first embodiment, a description thereon will be omitted.

As described above, According to the embodiment of the present invention, even if various additives are added to the developer, it may be possible to provide an image forming apparatus capable of preventing defects in image quality, such as low density and fogging, due to a charging failure caused by an increase in the density of the additives of the recovered developer.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrier;
a cleaning device that recovers a toner remaining on the image carrier; and
a developing device, wherein:
a toner recovered by the cleaning device is supplied to the developing device,
the cleaning device comprises:
a conductive brush member that is disposed on upstream of the image carrier in a rotation direction of the image carrier so as to be in contact with the image carrier, the conductive brush member recovering the toner remaining on the image carrier electrostatically; and
an elastic blade that is disposed on downstream of the image carrier so as to be in contact with the image carrier, wherein:
the toner recovered by the conductive brush member is supplied to the developing device and used in image formation again, and
the toner recovered by the elastic blade is discarded.

2. The image forming apparatus according to claim 1, wherein:
a cleaning additive is added to the toner, and
the cleaning additive is charged with a polarity opposite to that of the toner.

3. The image forming apparatus according to claim 1, wherein the conductive brush member is disposed above the elastic blade in a gravitational direction.

4. The image forming apparatus according to claim 1, further comprising:
a conveyance passage for reuse, through which the toner recovered by the cleaning device is supplied to the developing device, wherein:
the cleaning device further comprises a scraping member that abuts against a surface of the conductive brush member to scrape the toner recovered by the conductive brush member so as to guide a scraped toner to the conveyance passage.

5. The image forming apparatus according to claim 1, wherein the image carrier carries an electrostatic latent image, the developing device develops the electrostatic latent image using the toner to form a toner image on the image carrier, the image forming device further comprising a recording medium conveyance passage that conveys a recording medium and that the toner image formed on the image carrier is transferred onto the recording medium along the way of the recording medium conveyance passage, wherein a voltage applied to the conductive brush member is set so that the conductive brush member does not recover the toner remaining on the image carrier under a condition that the recording medium are jammed on the recording medium conveyance passage, or the toner image is continuously transferred onto a plurality of the recording medium on the recording medium conveyance passage.
